(19) United States
(12) Patent Application Publication
(10) Pub. No.: US 2024/0246769 A1
(43) Pub. Date: Jul. 25, 2024

(54) BELT CONVEYOR BRAKE SYSTEMS AND CONTROLLERS

(71) Applicant: Intelligrated Headquarters, LLC, Mason, OH (US)

(72) Inventors: Venkatesh RAIKAR, Charlotte, NC (US); Saravanan SADASIVAN, Charlotte, NC (US); Shivaraj KHOT, Charlotte, NC (US)

(21) Appl. No.: 18/411,824

(22) Filed: Jan. 12, 2024

(30) Foreign Application Priority Data
Jan. 19, 2023 (IN) 202311003781

(51) Int. Cl. B65G 23/08; B65G 23/26

(52) U.S. Cl. CPC B65G 23/08; B65G 23/26; B65G 2812/02148

(57) ABSTRACT

A belt conveyor system comprising one or more idler rollers, a slave roller, a drive roller coupled to the slave roller, wherein the drive roller configured to drive the slave roller, a belt extending in a continuous loop wrapping around the one or more idler rollers, the slave roller, and the drive roller, wherein the slave roller is configured to drive the belt, and a brake configured to actuate with at least one of: (i) select ones of the one or more idler rollers, and (ii) a portion of the belt in a position adjacent to the select ones of the one or more idler rollers.

### TECHNICAL FIELD

Various embodiments of the present disclosure relate to belt conveyor systems, and more particularly to brake systems for preventing loads from traversing a belt conveyor too quickly when operating at a decline.

### BACKGROUND

Controlling the movement of loads on belt conveyors can be a challenging endeavor, especially in situations where heavy loads (e.g., over 50 pounds) traveling at high speeds (e.g., 180 fpm) on a declining slope are abruptly stopped. A braking action may be applied on a belt conveyor to stop movement of loads on the belt conveyor. However, the net result of such is that the speed of a load is not properly controlled due to the load's inertia being greater than the sliding friction of conveyor components, such as belt and rollers. This may result in loads moving further than desired during stoppages and/or damage to the loads. Thus, there is a need for belt conveyor brake systems and controllers to solve the aforementioned problem.

### BRIEF SUMMARY

In accordance with various embodiments of the present disclosure, a belt conveyor system is provided. In some embodiments, the belt conveyor system comprises one or more idler rollers, a slave roller, a drive roller coupled to the slave roller, wherein the drive roller configured to drive the slave roller, a belt extending in a continuous loop wrapping around the one or more idler rollers, the slave roller, and the drive roller, wherein the slave roller is configured to drive the belt, and a brake configured to actuate with at least one of: (i) select ones of the one or more idler rollers, and (ii) a portion of the belt in a position adjacent to the select ones of the one or more idler rollers.

According to another embodiment, the belt conveyor system comprises one or more idler rollers, a drive roller configured to drive a belt, the belt extending in a continuous loop wrapping around the one or more idler rollers and the drive roller, and a brake configured to actuate with at least one of: (i) select ones of the one or more idler rollers, and (ii) a portion of the belt in a position adjacent to the select ones of the one or more idler rollers. In some embodiments, the one or more idler rollers comprise passive rollers that are capable of freely rotating. In some embodiments, the brake comprises a fixed U-shaped caliper configured externally of the continuous loop of the belt. In some embodiments, the position adjacent to the select ones of the one or more idler rollers is below the select ones of the idler rollers. In some embodiments, the brake is actuated by applying the brake upwards from beneath the belt placing the brake in direct contact with the portion of the belt. In some embodiments, the brake is configured to compress the portion of belt between the brake and the select ones of the one or more idler rollers. In some embodiments, the brake comprises a plate structure configured internally of the continuous loop of the belt, and on a side rail on at least one end of the select ones of the one or more idler rollers. In some embodiments, the brake is configured to apply frictional force to sidewalls portions of the select ones of the one or more idler rollers. In some embodiments, the brake comprises a butterfly structure configured within the continuous loop of the belt and between the select ones of the one or more idler rollers.

In some embodiments, the brake is configured to actuate laterally in one or two directions towards the select ones of the one or more idler rollers. In some embodiments, the select ones of the one or more idler rollers comprise lower diameter idler rollers. In some embodiments, the brake comprises a yoke structure including an arch on each opposing lateral side of the yoke structure. In some embodiments, the brake comprises a series of yoke structures. In some embodiments, the brake is configured to lift the select ones of the one or more idler roller from a neutral position to a lifted position.

According to another embodiment, the belt conveyor system comprises one or more idler rollers, a slave roller, a drive roller coupled to the slave roller, wherein the drive roller configured to drive the slave roller, a belt extending in a continuous loop wrapping around the one or more idler rollers, the slave roller, and the drive roller, wherein the slave roller is configured to drive the belt, and a brake configured to actuate with at least one of: (i) the drive roller, (ii) the slave roller, and (iii) a portion of the belt in a position adjacent to the drive roller and the slave roller.

In some embodiments, the brake comprises a fixed U-shaped caliper configured externally of the continuous loop of the belt. In some embodiments, the position adjacent to the drive roller and the slave roller is below at least one of the drive roller and the slave roller. In some embodiments, the brake is actuated by applying the brake upwards from beneath the belt placing the brake in direct contact with the portion of the belt. In some embodiments, the brake is configured to compress the portion of belt between the brake and at least one of the drive roller and the slave roller. In some embodiments, the brake comprises a plate structure configured internally of the continuous loop of the belt, and on a side rail on at least one end of the drive roller and the slave roller. In some embodiments, the brake is configured to apply frictional force to sidewalls portions of the drive roller and the slave roller. In some embodiments, the brake comprises a butterfly structure configured within the continuous loop of the belt and between the drive roller and the slave roller. In some embodiments, the brake is configured to actuate laterally in one or two directions towards the drive roller and the slave roller.

According to another embodiment, the belt conveyor system comprises one or more idler rollers comprising an internal brake, a slave roller comprising an internal brake, a drive roller coupled to the slave roller, wherein the drive roller configured to drive the slave roller, a belt extending in a continuous loop wrapping around the one or more idler rollers, the slave roller, and the drive roller, wherein the slave roller is configured to drive the belt, and wherein the internal brake of the one or more idler rollers and the internal brake of the slave roller are controlled and actuated by a controller associated with the drive roller.

According to another embodiment, a computer-implemented method for optimizing a lifespan of a belt conveyor is provided. In some embodiments, the computer-implemented method comprises receiving, by one or more processors, load and operating parameter data, determining, by the one or more processors, a load runaway value based on the load and operating parameter data, determining, by the one or more processors, whether a given load requires at least one of brake actuation and roller lifting based on the load runaway value, generating, by the one or more processors, a signal causing at least one of brake activation and roller lifting based on the determination.

In some embodiments, the load and operating parameter data is associated with transport of the given load being on a belt conveyor. In some embodiments, the load and operating parameter data comprises data representative of a weight of the given load, the given load's size, an angle of decline, and conveyor speed. In some embodiments, the runaway value comprises an estimation of the given load's momentum based on load weight and conveyor speed. In some embodiments, determining whether the given load requires at least one of brake actuation and roller lifting is further based on the load runway value exceeds a specific threshold.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein.

FIG. 1A, FIG. 1B, and FIG. 1C illustrate belt conveyor systems associated with caliper brakes in accordance with some embodiments discussed herein.

FIGS. 2A, 2B, 2C, 2D, and 2E illustrate belt conveyor systems associated with plate brakes in accordance with some embodiments discussed herein.

FIG. 3A and FIG. 3B illustrate belt conveyor systems associated with butterfly brakes in accordance with some embodiments discussed herein.

FIGS. 4A, 4B, 4C, and 5 illustrate belt conveyor systems associated with yoke brakes in accordance with some embodiments discussed herein.

FIGS. 6A, 6B, and 7 illustrate belt conveyor systems associated with lifting rollers in accordance with some embodiments discussed herein.

FIG. 8A and FIG. 8B illustrate belt conveyor systems associated with internal brakes in accordance with some embodiments discussed herein.

FIG. 9 illustrates an example belt conveyor computing system in accordance with some embodiments discussed herein.

FIG. 10 illustrates a flowchart of a method for optimizing a lifespan of a belt conveyor in accordance with some embodiments discussed herein.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As described above, controlling heavy loads when operation of belt conveyors are stopped, especially on declining slopes, present challenges and difficulties. Fixed rollers (e.g., bolt-in tubes that do not rotate) may be used to provide additional frictional force to overcome a load's inertia. Fixed rollers may offer higher friction in comparison to standard rotating rollers. For example, the coefficient of friction provided by fixed rollers may be in the range of 0.2-0.5, whereas the coefficient of friction of standard rollers may be in the range of 0.02-0.05. However, there are disadvantages related to using fixed rollers. For example, due to higher friction caused by bolt-in rollers, a belt conveyor may require a higher power motor or multiple motor driven rollers to convey loads, which increases the cost and maintenance of such a conveyor. The higher friction may also increase continuous wear of a belt over a fixed roller.

Accordingly, various embodiments of the present disclosure provide brake systems that do not require the use of fixed rollers. By avoiding the use of fixed rollers, less power may be consumed during operation. Additionally, the disclosed brake system may ensure positional accuracy of a load when a belt conveyor is stopped.

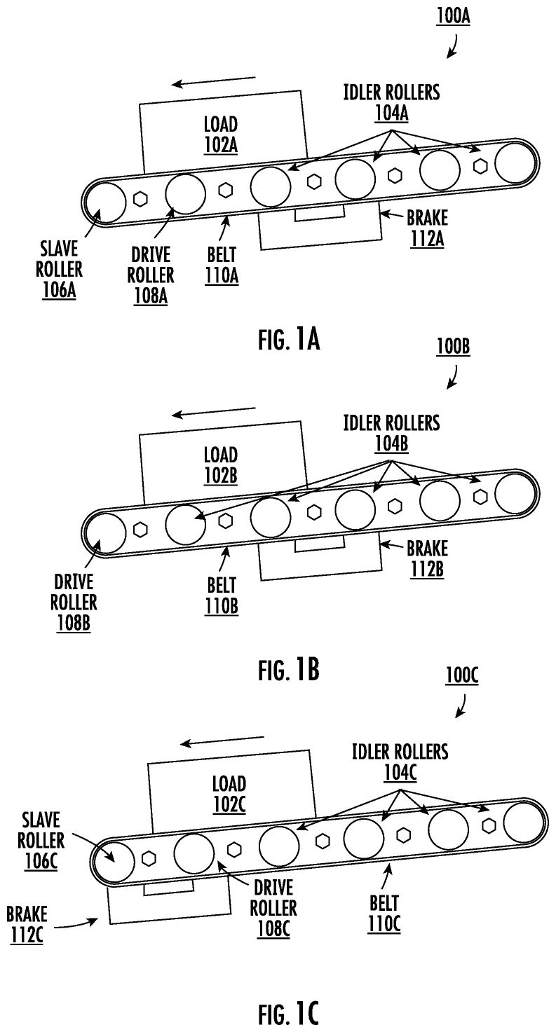

Referring now to FIG. 1A, a cross-section side view of a belt conveyor system 100A is depicted according to an embodiment of the present disclosure. Belt conveyor system 100A comprises a belt 110A that extends in a continuous loop that wraps around idler rollers 104A, slave roller 106A and drive roller 108A. Belt 110A may be driven by drive roller 108A and/or slave roller 106A (e.g., coupled to or otherwise controlled drive roller 108A) to transport load 102A in a given direction. For example, belt 110A may be driven by slave roller 106A which is driven by drive roller 108A.

As described herewith, a drive roller may comprise a motorized roller that may be coupled to and used to drive a slave roller. As described herewith, a slave roller may comprise a roller that is coupled to a and controlled by a drive roller. The slave roller may be driven by a drive roller to pull a belt of a belt conveyor system. The belt conveyor system 100A further comprises idler rollers 104A. As described herewith, an idler roller may refer to a passive roller that is capable of freely rotating, such as in a direction that a conveyor belt is driven. An idler roller may provide low rolling friction surfaces for which a belt may glide over during operation.

Brake 112A is configured externally of the continuous loop formed with belt 110A and under a portion of belt 110A beneath select ones of the idler rollers 104A, as depicted in FIG. 1A. As described herewith, a brake may refer to a mechanism for stopping motion of rollers. A brake may comprise electro-magnetic, pneumatic, or hydraulic components configured to receive an actuation signal based on, e.g., detection by an imaging system or sensor associated with a next zone indicative of an accumulation condition or emergency. In some embodiments, upon stopping operation of belt conveyor system 100A (e.g., after receiving a signal based on image detection or sensor data associated with a next zone), brake 112A may be actuated.

Brake 112A comprises a fixed U-shaped caliper that may be applied upwards from beneath belt 110A such that brake 112A is in direct contact with the portion of belt 110A below the select ones of the idler rollers 104A. By actuating brake 112A, the portion of belt 110A in contact with brake 112A may be compressed between brake 112A and the select ones of the idler rollers 104A to apply frictional force against belt 110A to stop belt 110A from continued movement. Additionally, brake 112A may hold the select ones of the idler rollers 104A such that the idler rollers 104A are prohibited from rotation while brake 112A is actuated, thus effectively turning the idler rollers 104A into fixed rollers. As understood by one of ordinary skill in the art, idler rollers 104A and brake 112A are not limited to the depicted embodiment. For example, belt conveyor system 100A may comprise any number of brake 112A configured on any given ones of idler rollers 104A.

FIG. 1B, presents a cross-section side view of a belt conveyor system 100B according to an embodiment of the present disclosure. Belt conveyor system 100B is substantially similar to the belt conveyor system 100A with the exception of belt 110B being directly driven by drive roller 108B to transport load 102B in a given direction. Belt conveyor system 100B comprises a belt 110B that extends in a continuous loop that wraps around idler rollers 104B and drive roller 108B.

Brake 112B is configured externally of the continuous loop formed with belt 110B and under a portion of belt 110B beneath select ones of the idler rollers 104B, as depicted in FIG. 1B. In some embodiments, upon stopping operation of belt conveyor system 100B (e.g., after receiving a signal based on image detection or sensor data associated with a next zone), brake 112B may be actuated. Brake 112B comprises a fixed U-shaped caliper that may be applied upwards from beneath belt 110B such that brake 112B is in direct contact with the portion of belt 110B below the select ones of the idler rollers 104B. By actuating brake 112B, the portion of belt 110B in contact with brake 112B may be compressed between brake 112B and the select ones of the idler rollers 104B to apply frictional force against belt 110B to stop belt 110B from continued movement. Additionally, brake 112B may hold the select ones of the idler rollers 104B such that the idler rollers 104B are prohibited from rotation while brake 112B is actuated, thus effectively turning the idler rollers 104B into fixed rollers. As understood by one of ordinary skill in the art, idler rollers 104B and brake 112B are not limited to the depicted embodiment. For example, belt conveyor system 100B may comprise any number of brake 112B configured on any given ones of idler rollers 104B.

FIG. 1C presents cross-section side view of a belt conveyor system 100C according to an embodiment of the present disclosure. Belt conveyor system 100C comprises a belt 110C that extends in a continuous loop that wraps around idler rollers 104C, slave roller 106C and drive roller 108C. Belt 110C may be driven by drive roller 108C and/or slave roller 106C (e.g., coupled to or otherwise controlled drive roller 108C). For example, belt 110C may be directly driven by slave roller 106C which is driven by drive roller 108C. The belt conveyor system 100C further comprises idler rollers 104C.

Compared to FIG. 1A, brake 112C is configured externally of the continuous loop formed with belt 110C and under a portion of belt 110C beneath slave roller 106C and drive roller 108C, instead of the idler rollers 104C. In some embodiments, upon stopping operation of belt conveyor system 100C (e.g., after receiving a signal based on image detection or sensor data associated with a next zone indicative of an accumulation condition or an emergency), brake 112C may be actuated. Actuating brake 112C comprises a fixed U-shaped caliper that may be applied upwards from beneath belt 110C such that brake 112C is in direct contact with the portion of belt 110C at slave roller 106C and/or drive roller 108C. By actuating brake 112C, the portion of belt 110C in contact with brake 112C may be compressed between brake 112C and one or both of slave roller 106C and drive roller 108C to apply frictional force against belt 110C to stop movement of the belt 110C. This option may eliminate the need for an internal brake inside the drive roller 108C and eliminate the rotation of the slave roller 106C due to slippage of a drive belt coupling drive roller 108C to slave roller 106C even after drive roller 108C has stopped.

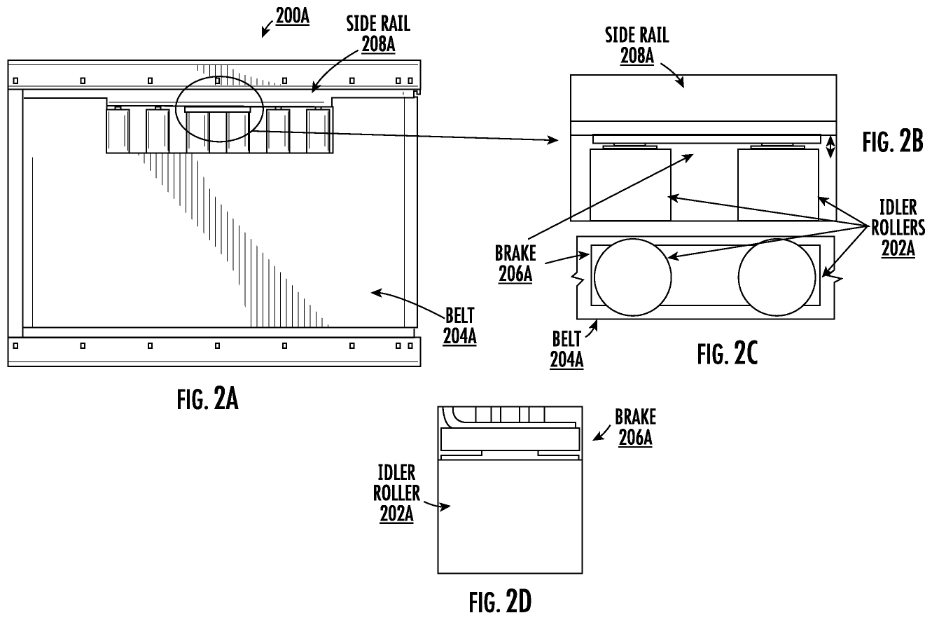

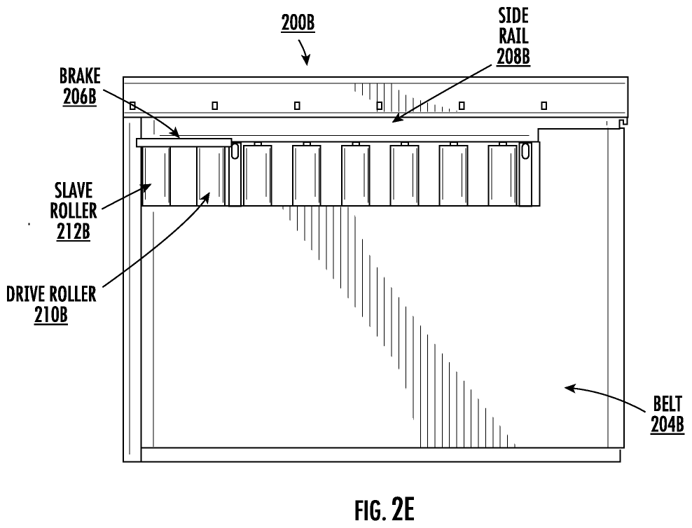

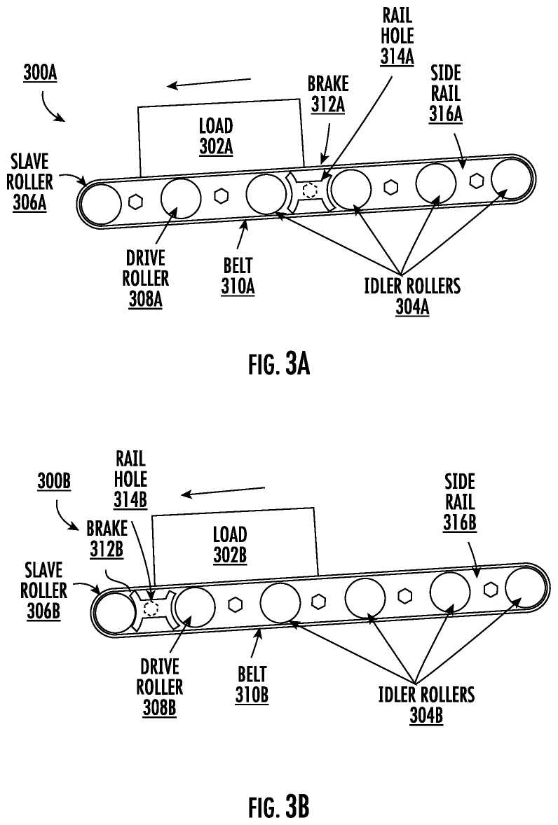

FIG. 2A presents a partial cutaway front view of belt conveyor system 200A according to an embodiment of the present disclosure. Belt conveyor system 200A comprises idler rollers 202A, belt 204A, and brake 206A. In some embodiments, belt conveyor system 200A further comprises other types of rollers, such as a drive roller and a slave roller that drive belt 204A in a given direction. Belt 204A extends in a continuous loop that wraps around idler rollers 202A and any other type of rollers comprised in belt conveyor system 200A. For example, belt 204A may be driven by a slave roller which is driven by a drive roller.

FIG. 2B presents a portion of the partial cutaway front view of belt conveyor system 200A. FIG. 2C presents a bottom-side view of belt conveyor system 200A. FIG. 2D depicts a side view of idler roller 202A and brake 206A. Brake 206A comprises a plate structure configured internally of the continuous loop formed with belt 204A, and on a side rail 208A on at least one end of one or more of idler rollers 202A. Brake 206A may be actuated towards one or more idler rollers 202A such that frictional force is applied to the sidewall portions of the one or more idler rollers 202A to decelerate rotational movement of the one or more idler rollers 202A, and prohibiting idler rollers 202A to rotate while brake 206A is actuated, thus effectively turning the idler rollers 202A into fixed rollers. As understood by one of ordinary skill in the art, idler rollers 202A and brake 206A are not limited to the depicted embodiment. For example, belt conveyor system 200A may comprise any number of brake 206A configured on any given ones of idler rollers 202A.

FIG. 2E presents a partial cutaway front view of belt conveyor system 200B according to an embodiment of the present disclosure. Belt conveyor system 200B comprises a belt 204B, brake 206B, a drive roller 210B, and a slave roller 212B. The belt conveyor system 200B may further comprise idler rollers. Belt 204B extends in a continuous loop that wraps around slave roller 212B, drive roller 210B, and any other types of rollers comprised in belt conveyor system 200B. Belt 204B may be driven by drive roller 210B and/or slave roller 212B. For example, belt 204B may be directly drive by slave roller 212B which is driven by drive roller 210B.

Brake 206B comprises a plate structure configured internally of the continuous loop formed with belt 204B, and on a side rail 208B on at least one end of drive roller 210B and slave roller 212B in contrast to brake 206A that is configured on at least one end of idler rollers, as described above with respect to the description of FIGS. 2A through 2D. As such, brake 206B comprises may be actuated to apply frictional force to the sidewalls portions of drive roller 210B and/or slave roller 212B to decelerate rotational movement of drive roller 210B and/or slave roller 212B, which drive(s) the belt 204B. The embodiment depicted in FIG. 2E may reduce or eliminate the rotation of slave roller 212B due to slippage of a drive belt coupling drive roller 210B to slave roller 212B even after the drive roller 210B is stopped.

FIG. 3A presents a cross-section side view of a belt conveyor system 300A according to an embodiment of the present disclosure. Belt conveyor system 300A comprises idler rollers 304A, slave roller 306A, drive roller 308A, belt 310A, and brake 312A. Belt 310A extends in a continuous loop that wraps around idler rollers 304A, slave roller 306A and drive roller 308A. Belt 310A may be driven by drive roller 308A and/or slave roller 306A (e.g., coupled to or otherwise controlled drive roller 308A) to transport load 302A in a given direction. For example, belt 310A may be driven by slave roller 306A which is driven by drive roller 308A.

As depicted, brake 312A may be mounted within the continuous loop formed with belt 310A onto a side rail 316A via rail hole 314A between a select pair of idler rollers 304A. Brake 312A comprises a butterfly structure operable to actuate laterally in one or two directions towards the select pair of idler rollers 304A. For example, brake 312A may be configured to be placed in direct contact with roller surface(s) of one or both of the select pair of idler rollers 304A to apply frictional resistance sufficient to decelerate rotational movement of one of idler rollers 304A in one direction or decelerate rotational movement of both of the select pair of idler rollers 304A in opposing directions. Additionally, brake 312A may hold the idler rollers 304A such that the idler rollers 304A are prohibited from rotation while brake 312A is actuated, thus effectively turning the idler rollers 304A into fixed rollers. As understood by one of ordinary skill in the art, idler rollers 304A and brake 312A are not limited to the depicted embodiment. For example, belt conveyor system 300A may comprise any number of brake 312A configured on any given ones of idler rollers 304A.

FIG. 3B presents a cross-section side view of a belt conveyor system 300B according to an embodiment of the present disclosure. Belt conveyor system 300B comprises idler rollers 304B, slave roller 306B, drive roller 308B, belt 310B, and brake 312B. Belt 310B extends in a continuous loop that wraps around idler rollers 304B, slave roller 306B and drive roller 308B. Belt 310B may be driven by drive roller 308B and/or slave roller 306B (e.g., coupled to or otherwise controlled drive roller 308B) to transport load 302B in a given direction. For example, belt 310B may be driven by slave roller 306B which is driven by drive roller 308B.

In the embodiment depicted in FIG. 3B, brake 312B is configured between slave roller 306B and drive roller 308B as opposed to brake 312A configured between a pair of idler rollers 304A as described above with respect to the description of FIG. 3A. Brake 312B may be mounted within the continuous loop formed with belt 310B onto a side rail 316B via rail hole 314B between slave roller 306B and drive roller 308B. Brake 312B comprises a butterfly structure operable to actuate laterally in one or two directions towards either or both the slave roller 306B and the drive roller 308B. For example, brake 312B may be configured to be placed in direct contact with roller surface(s) one or both of slave roller 306B and drive roller 308B to apply frictional resistance sufficient to decelerate rotational movement of one of slave roller 306B or drive roller 308B in one direction or both slave roller 306B and drive roller 308B in opposing directions. As such, the embodiment depicted in FIG. 3B may reduce or eliminate the rotation of slave roller 306B due to slippage of the coupling (e.g., O-belt/poly-v) between drive roller 308B and slave roller 306B even after the drive roller 308B is stopped.

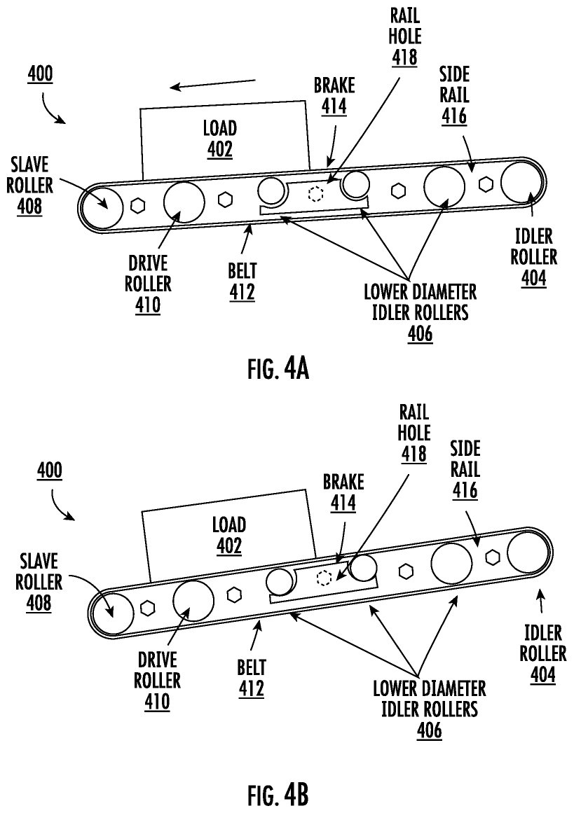

FIG. 4A presents a cross-section side view of a belt conveyor system 400 according to an embodiment of the present disclosure. Belt conveyor system 400 comprises an idler roller 404, lower diameter idler rollers 406, slave roller 408, drive roller 410, belt 412, and brake 414. Belt 412 extends in a continuous loop that wraps around idler roller 404, lower diameter idler rollers 406, slave roller 408, and drive roller 410. Belt 412 may be driven by drive roller 410 and/or slave roller 408 (e.g., coupled to or otherwise controlled drive roller 410) to transport load 402 in a given direction. For example, belt 412 may be driven by slave roller 408 which is driven by drive roller 410.

As described herewith, a lower diameter idler roller may refer to an idler roller that is smaller in diameter size relative to an ordinary idler roller to accommodate fitment of at least a portion of a brake. Brake 414 may be mounted within the continuous loop formed with belt 412 onto a side rail 416 via rail hole 418 between a select pair of the lower diameter idler rollers 406. Brake 414 comprises a yoke structure including an arch on each opposing lateral side of the yoke structure that conforms to at least a portion of a circumference corresponding to roller surface(s) of one of the select pair of lower diameter idler rollers 406 brake 414 is configured therebetween, as depicted in FIG. 4A.

FIG. 4B depicts belt conveyor system 400 with actuation of brake 414 according to an embodiment of the present disclosure. Actuating brake 414 may provide frictional resistance against the select pair of lower diameter idler rollers 406 by engaging brake 414 with the select pair of lower diameter idler rollers 406. Actuation of brake 414 may comprise movement of brake 414 in a vertical direction upwards or at an angle in a radial direction such that the arches of the yoke structure of brake 414 are applied or placed in contact with respective interfacing ones of the select pair of lower diameter idler rollers 406 to decelerate rotational movement of the interfacing ones of the select pair of lower diameter idler rollers 406. Additionally, brake 414 may hold the select pair of lower diameter idler rollers 406 such that the select pair lower diameter idler rollers 406 are prohibited from rotation while brake 414 is actuated, thus effectively turning the select pair of lower diameter idler rollers 406 into fixed rollers.

Alternatively, brake 414 may be actuated to engage with an inner surface of belt 412 while simultaneously engaging with lower diameter idler rollers 406 to provide additional frictional resistance as depicted in FIG. 4C. Brake 414 may be actuated to engage with both lower diameter idler rollers 406 and belt 412. Actuating brake 414 may comprise movement of brake 414 in a vertical direction upwards causing the arches of the yoke structure of brake 414 to be applied or placed in contact with respective interfacing ones of the lower diameter idler rollers 406 while simultaneously causing a top portion of brake 414 to be applied or placed in contact with belt 412 towards the top of belt conveyor system 400.

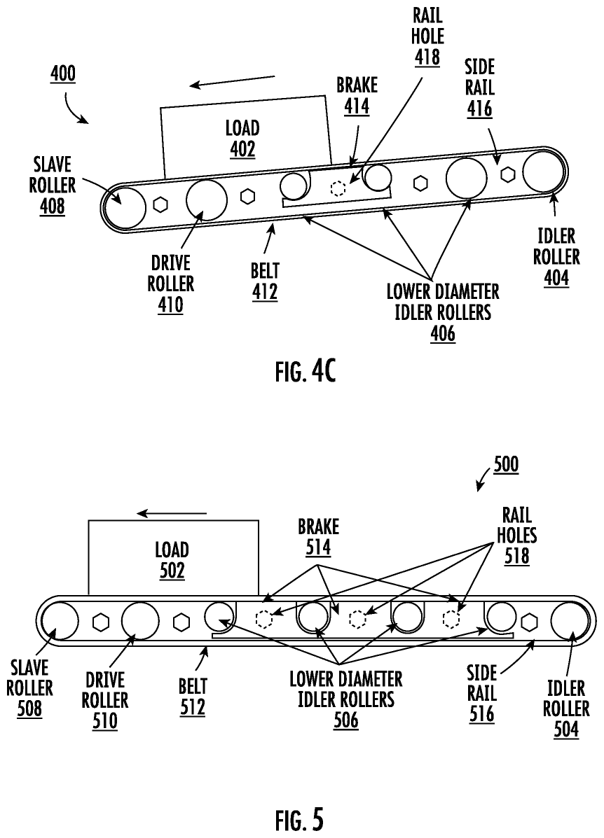

FIG. 5 depicts presents a cross-section side view of a belt conveyor system 500 according to an embodiment of the present disclosure. Belt conveyor system 500 comprises an idler roller 504, lower diameter idler rollers 506, slave roller 508, drive roller 510, belt 512, and brake 514. Belt 512 extends in a continuous loop that wraps around idler roller 504, lower diameter idler rollers 506, slave roller 508, and drive roller 510. Belt 512 may be driven by drive roller 510 and/or slave roller 508 (e.g., coupled to or otherwise controlled drive roller 510) to transport load 502 in a given direction. For example, belt 512 may be driven by slave roller 508 which is driven by drive roller 510.

Brake 514 may comprise a series of brakes or a single brake with a yoke structure (similar to brake 414) capable of applying frictional resistance to a plurality of lower diameter idler rollers 506 while simultaneously being applied or placed in contact with an inner surface of belt 512 towards the top of belt conveyor system 500. In some embodiments, brake 514 may comprise a series of independent brake components that may be individually actuated based on, for example, a required braking force. Brake 514 may be mounted within the continuous loop formed with belt 512 onto a side rail 516 via rail holes 518 between the lower diameter idler rollers 506.

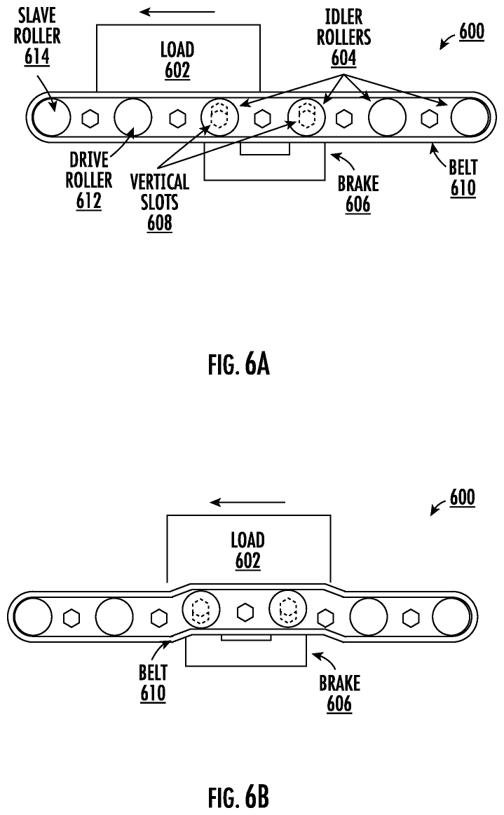

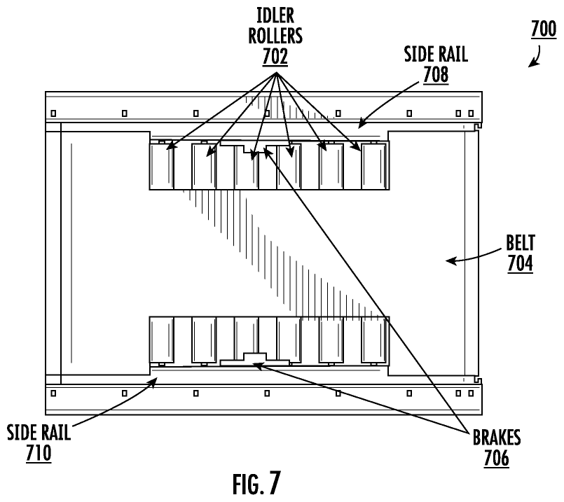

FIG. 6A depicts presents a cross-section side view of a belt conveyor system 600 according to an embodiment of the present disclosure. Belt conveyor system 600 comprises idler rollers 604, brake 606, belt 610, drive roller 612, and slave roller 614. Belt 610 extends in a continuous loop that wraps around idler rollers 604, drive roller 612, and slave roller 614. Belt 610 may be driven by drive roller 612 and/or slave roller 614 (e.g., coupled to or otherwise controlled drive roller 612) to transport load 602 in a given direction. For example, belt 610 may be driven by slave roller 614 which is driven by drive roller 612.

Select ones of idler rollers 604 may be mounted on vertical slots 608. The vertical slots 608 may allow the select ones of idler rollers 604, mounted on the vertical slots 608, to move vertically when acted upon. Brake 606 comprises a fixed U-shaped caliper that may be applied upwards when actuated. Brake 606 is configured externally of the continuous loop formed with belt 610 and under a portion of belt 610 beneath the select ones of the idler rollers 604 mounted on the vertical slots 608. As such, brake 606 may be actuated upwards from beneath belt 610 such that brake 606 is in direct contact with the portion of belt 610 below the select ones of the idler rollers 604 mounted on the vertical slots 608. As such, frictional force may be applied against belt 610 via compression between brake 606 and select ones of the idler rollers 604, and additional rolling friction may be created by prohibiting idler rollers 604 from rotation.

Actuating the brake 606 may also provide force to lift the select ones of the idler rollers 604 upwards from a neutral position to a lifted position when belt conveyor system 600 is stopped to help stop the load 602, as depicted in FIG. 6B. As understood by one of ordinary skill in the art, idler roller 604, brake 606, and vertical slots 608 are not limited to the depicted embodiment. For example, brake 606 may comprise any shape and size configured to lift up against any portion of belt 610 under any number of idler rollers 604 mounted on respective any number of vertical slots 608.

FIG. 7 presents a partial cutaway front view of belt conveyor system 700 according to an embodiment of the present disclosure. Belt conveyor system 700 comprises idler rollers 702, belt 704, and brakes 706. In some embodiments, belt conveyor system 700 further comprises other types of rollers, such as a drive roller and a slave roller that drive belt 704 in a given direction. Belt 704 extends in a continuous loop that wraps around idler rollers 702 and any other type of rollers comprised in belt conveyor system 700. For example, belt 704 may be driven by a slave roller which is driven by a drive roller. Belt conveyor system 700 may also comprise vertical slots (e.g., similar or identical to vertical slots 608) for which select ones of idler rollers 702 may be mounted on. The vertical slots may allow the select ones of idler rollers 702, mounted on the vertical slots, to move vertically when acted upon.

Brakes 706 may be configured externally of the continuous loop formed with belt 704 and under a portion of the belt 704 beneath the select ones of the idler rollers 702 and at opposing ends of the select ones of idler rollers 702. Brakes 706 may comprise a fixed U-shaped caliper, a block, or any shape suitable for application with belt 704 such that brakes 706 are in direct contact with portions of belt 704 coincident with the position of brakes 706. Actuating brakes 706 may provide force to lift the select ones of the idler rollers 702 upwards from a neutral position to a lifted position when belt conveyor system 700 is stopped to help stop the load 702. Along with lifting, the portions of belt 704 in contact with brakes 706 may be compressed between brakes 706 and the select ones of the idler rollers 702 to apply frictional force against belt 704. Additionally, brakes 706 may hold the select ones of the idler rollers 702 such that the select ones of the idler rollers 702 are prohibited from rotation while brakes 706 is actuated, thus effectively turning the select ones of the idler rollers 702 into fixed rollers. As understood by one of ordinary skill in the art, idler rollers 702 and brakes 706 are not limited to the depicted embodiment. For example, belt conveyor system 700 may comprise any number of brakes 706 configured on any given ones of idler rollers 702.

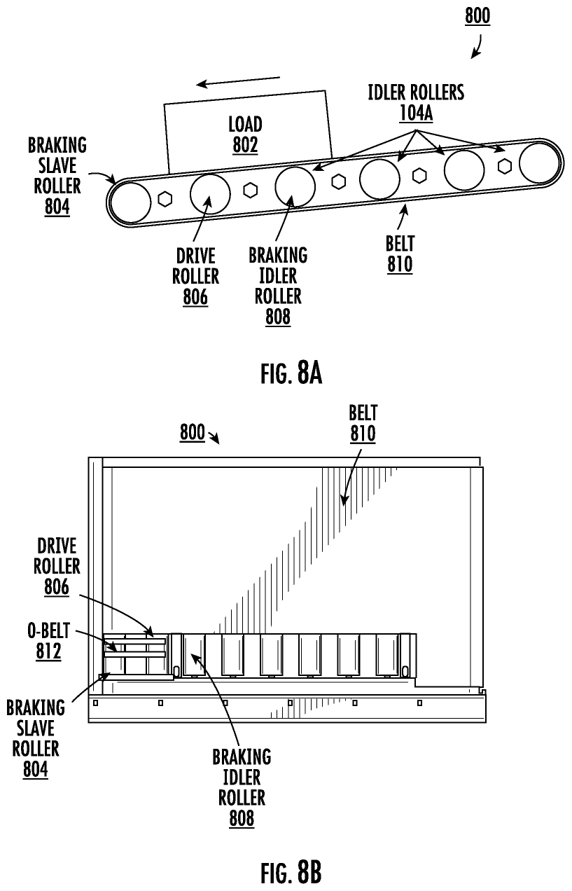

FIG. 8A depicts presents a cross-section side view of a belt conveyor system 800 according to an embodiment of the present disclosure. Belt conveyor system comprises idler roller 802, braking slave roller 804, drive roller 806, braking idler roller 808, and belt 810. Belt 810 extends in a continuous loop that wraps around idler roller 802, braking slave roller 804, drive roller 806, and braking idler roller 808. Belt 810 may be driven by drive roller 806 and/or braking slave roller 804 (e.g., coupled to or otherwise controlled drive roller 806) to transport load 802 in a given direction. For example, belt 810 may be driven by braking slave roller 804 which is driven by drive roller 806. Braking slave roller 804 may comprise a slave roller including an inbuilt internal brake. As understood by one of ordinary skill in the art, braking idler roller 808 is not limited to the depicted embodiment. For example, belt conveyor system 800 may comprise any number of braking idler roller 808 or any of idler rollers 802 may be replaced with braking idler rollers.

FIG. 8B depicts a partial cutaway front view of belt conveyor system 800 according to an embodiment of the present disclosure. As depicted in FIG. 8B, braking slave roller 804 may drive the belt 810 which may in turn be driven by drive roller 806 using O-belt 812. The inbuilt internal brake of braking slave roller 804 may be utilized in place of a brake at the drive roller 806 to increase the life and durability of drive roller 806. The inbuilt internal brake of braking slave roller 804 may also prevent slippage between O-belt 812 and braking slave roller 804 due to inertia of load 802 and/or belt 810, and thus preventing load 802 from moving further even after stoppage of belt conveyor system 800.

Drive roller 808 may comprise a controller communicatively coupled to braking slave roller 804 for actuating the inbuilt internal brake of braking slave roller 804. According to one embodiment, drive roller 806 may stop operation in response to a signal received by drive belt conveyor system 800 (e.g., from an imaging system or sensor associated with a next zone) and the controller may communicate an electronic or electrical signal to the inbuilt internal brake of braking slave roller 804 to actuate and stop movement of braking slave roller 804. Braking idler rollers 808 may also be used in conjunction with braking slave roller 804 to provide additional rolling friction when belt conveyor system 800 is stopped. Braking idler roller 808 may comprise an idler roller including an inbuilt internal brake. Accordingly, when the inbuilt internal brake of braking idler roller 808 is actuated, braking idler roller 808 may be prohibited from rotation, thus effectively turning the braking idler roller 808 into a fixed roller. The internal brake of the braking idler roller 808 may also be controlled and actuated by the controller of the drive roller 808 in response to a signal received by drive belt conveyor system 800.

According to another aspect of the present disclosure, a system and method for optimizing a lifespan of a belt conveyor is disclosed. Conventionally, brakes may be applied every time a belt conveyor is stopped. However, it may not be necessary to apply brakes on a belt conveyor system for every instance the belt conveyor system is stopped. That is, excessive braking or applying braking every time a belt conveyor system is stopped may reduce the life of brake components and the belt conveyer system itself.

In some embodiments, any of the disclosed belt conveyor system may comprise a computing system including memory and one or more processors communicatively coupled to the memory, wherein the one or more processors are configured to optimize the life of the belt conveyer system. The one or more processors may determine braking and/or lifting of rollers based on data, such as load weight, load size, angles of declines, and conveyor speed.

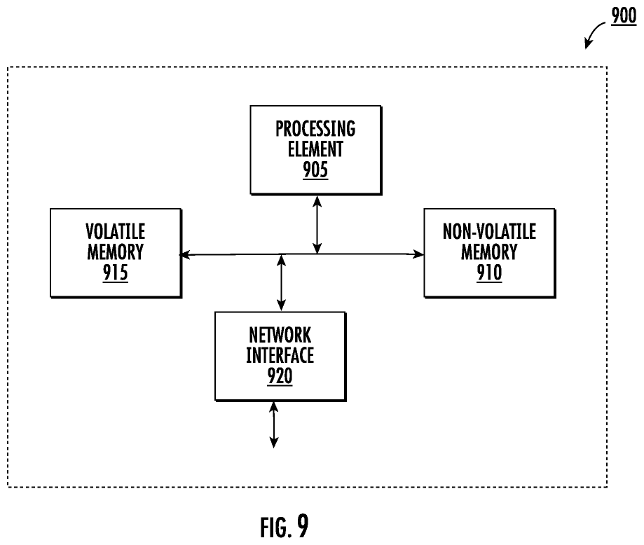

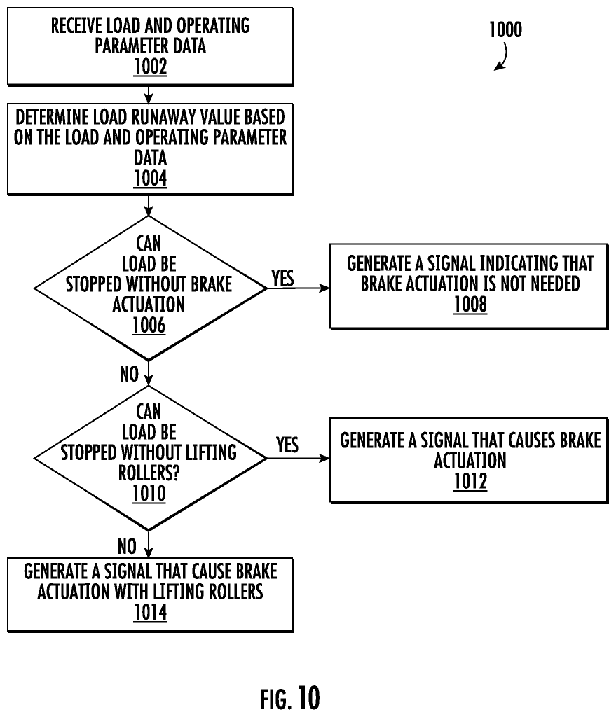

FIG. 9 provides a schematic of a belt conveyor computing system according to one embodiment of the present disclosure. The belt conveyor computing system 900 may include one or more network interfaces 920 for communicating with various computing entities, such as by communicating data, content, information, and/or similar terms used herein interchangeably that can be transmitted, received, operated on, processed, displayed, stored, and/or the like. In one embodiment, the belt conveyor computing system 900 may include, or be in communication with, one or more processing elements 905 (also referred to as processors, processing circuitry, and/or similar terms used herein interchangeably) that communicate with other elements within the belt conveyor computing system 900 via a bus, for example. As will be understood, the processing element 905 may be embodied in a number of different ways.

For example, the processing element 905 may be embodied as one or more complex programmable logic devices (CPLDs), microprocessors, multi-core processors, coprocessing entities, application-specific instruction-set processors (ASIPs), microcontrollers, and/or controllers. Further, the processing element 905 may be embodied as one or more other processing devices or circuitry. The term circuitry may refer to an entirely hardware embodiment or a combination of hardware and computer program products. Thus, the processing element 905 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 905 may be configured for a particular use or configured to execute instructions stored in volatile or non-volatile media or otherwise accessible to the processing element 905. As such, whether configured by hardware or computer program products, or by a combination thereof, the processing element 905 may be capable of performing steps or operations according to embodiments of the present disclosure when configured accordingly.

In one embodiment, the belt conveyor computing system 900 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 910, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the belt conveyor computing system 900 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 915, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 905. Thus, the databases, database instances, database management systems, data, applications, programs, program modules, scripts, source code, object code, byte code, compiled code, interpreted code, machine code, executable instructions, and/or the like may be used to control certain aspects of the operation of the belt conveyor computing system 900 with the assistance of the processing element 905 and operating system.

As indicated, in one embodiment, the belt conveyor computing system 900 may also include one or more network interfaces 920 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the belt conveyor computing system 900 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the belt conveyor computing system 900 may include, or be in communication with, one or more input elements, such as a keyboard input, a mouse input, a touch screen/display input, motion input, movement input, audio input, pointing device input, joystick input, keypad input, and/or the like. The belt conveyor computing system 900 may also include, or be in communication with, one or more output elements (not shown), such as audio output, video output, screen/display output, motion output, movement output, and/or the like.

FIG. 10 presents a flowchart of a process for optimizing a lifespan of a belt conveyor according to some embodiments of the present disclosure. The process 1000 includes example operations that may be performed by the belt conveyor computing system 900, and belt conveyor computing system 900 comprises means, such as processing element 905, memories 910 and 915, network interface 920, and/or the like, for performing the example operations. In some embodiments, via the various steps/operations of the process 900, the belt conveyor computing system 900 may determine, for a given load in a select zone on a belt conveyor, whether braking or braking and roller lifting operations are required for stopping the given load.

At step 1002, the belt conveyor computing system 900 receives load and operating parameter data. The load and operating parameter data may be associated with a given load being transported on a belt conveyor associated with the belt conveyor computing system 900. The load and operating parameter data may comprise data representative of a weight of the given load, the given load's size, an angle of decline, and conveyor speed. Data representative of weight of the given load may be obtained by measurement using one or more loadcells or by scan of a product barcode or quick response (QR) code of the given load. Data representative of the given load's size (e.g., length, width, height) may be determined by an imaging system or barcode/QR code. Data representative of angle of decline may be a fixed value that may be preconfigured/programmed or entered manually, or a variable value that may be determined from one or more sensors or an inbuilt accelerometer within given rollers. Data representative of conveyor speed may be retrieved from operation configuration data that may be programmed or select for operation of the belt conveyor associated with belt conveyor computing system 900. Alternatively, or additionally, data representative of conveyor speed may comprise belt speed and load speed monitored by optical speed sensors.

At step 1004, the belt conveyor computing system 900 determines a load runaway value based on the load and operating parameter data. In one embodiment, determining the runaway value may comprise an estimation of the given load's momentum based on load weight and conveyor speed. However, load size and angle of decline may also be contributing factors to the load runaway value. In another embodiment, determining the runaway value may comprise an estimation of inertia at one or more rollers (e.g., idler roller, lower diameter idler roller, braking idler roller, slave roller, braking slave roller, drive roller, or any other roller associated with belt conveyor computing system 900) based on the load and operating parameter data.

At step 1006, the belt conveyor computing system 900 determines whether the given load can be stopped without brake actuation based on the load runaway value. In some embodiments, if the load runaway value is less than a specific threshold and not capable of moving after stoppage of the belt conveyer, the belt conveyor computing system 900 may determine that the given load can be stopped without brake actuation. In some embodiments, if the given load can be stopped without brake actuation, at step 1008, the belt conveyor computing system 900 generates a signal indicating that brake actuation is not needed.

In some embodiments, if the load runaway value is over a specific threshold such that the given load carries excessive momentum that causes it to move even after stoppage of the belt conveyer, the belt conveyor computing system 900 may determine that the given load requires brake actuation to be stopped. In some embodiments, if the given load cannot be stopped without brake actuation, at step 1010, the belt conveyor computing system 900 determines whether the given load can be stopped without lifting rollers. According to various embodiments of the present disclosure, determining whether the given load can be stopped without lifting rollers comprises determining a braking force required to stop the given load. The required braking force to stop the given load may be determined based on, for example, conveyor speed and slippage between a belt of the belt conveyor and the given load. Slippage between a belt of the belt conveyor and the given load may be determined based on, for example, belt speed and load speed. In some embodiments, if the required braking force is less than or equal to a braking threshold, at step 1012, the belt conveyor computing system 900 generates a signal that causes brake actuation, without lifting rollers.

In some embodiments, determining whether the given load can be stopped without lifting rollers may further comprise determining a number of brake components to actuate and/or a number idler rollers to lift. In one embodiment, data representative of the given load's size may be used to determine the number of brake components to actuate and a number idler rollers to lift, if needed. As such, a signal that causes brake actuation may include a determined number of brake components to actuate.

In some embodiments, if the required braking force is greater than the braking threshold, at step 1014, the belt conveyor computing system 900 generates a signal that causes brake actuation with lifting rollers. The signal causing brake actuation with lifting rollers may comprise a determined number of brake components to actuate and a determined number idler rollers to lift from a neutral position to a lifted position.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A belt conveyor system comprising:
one or more idler rollers;
a slave roller;
a drive roller coupled to the slave roller, wherein the drive roller configured to drive the slave roller;
a belt extending in a continuous loop wrapping around the one or more idler rollers, the slave roller, and the drive roller, wherein the slave roller is configured to drive the belt; and
a brake configured to actuate with at least one of: (i) select ones of the one or more idler rollers, and (ii) a portion of the belt in a position adjacent to the select ones of the one or more idler rollers.

2. A belt conveyor system comprising:
one or more idler rollers;
a drive roller configured to drive a belt;
the belt extending in a continuous loop wrapping around the one or more idler rollers and the drive roller; and
a brake configured to actuate with at least one of: (i) select ones of the one or more idler rollers, and (ii) a portion of the belt in a position adjacent to the select ones of the one or more idler rollers.

3. The belt conveyor system of claim 1 or claim 2, wherein the one or more idler rollers comprise passive rollers that are capable of freely rotating.

4. The belt conveyor system of any of claims 1-3, wherein the brake comprises a fixed U-shaped caliper configured externally of the continuous loop of the belt.

5. The belt conveyor system of any of claims 1-4, wherein the position adjacent to the select ones of the one or more idler rollers is below the select ones of the idler rollers.

6. The belt conveyor system of any of claims 1-5, wherein the brake is actuated by applying the brake upwards from beneath the belt placing the brake in direct contact with the portion of the belt.

7. The belt conveyor system of any of claims 1-6, wherein the brake is configured to compress the portion of belt between the brake and the select ones of the one or more idler rollers.

8. The belt conveyor system of claim 1 or claim 2, wherein the brake comprises a plate structure configured internally of the continuous loop of the belt, and on a side rail on at least one end of the select ones of the one or more idler rollers.

9. The belt conveyor system of any of claim 1, 2 or 8, wherein the brake is configured to apply frictional force to sidewalls portions of the select ones of the one or more idler rollers.

10. The belt conveyor system of claim 1 or claim 2, wherein the brake comprises a butterfly structure configured within the continuous loop of the belt and between the select ones of the one or more idler rollers.

11. The belt conveyor system of claim 1, 2 or 10, wherein the brake is configured to actuate laterally in one or two directions towards the select ones of the one or more idler rollers.

12. The belt conveyor system of claim 1 or claim 2, wherein the select ones of the one or more idler rollers comprise lower diameter idler rollers.

13. The belt conveyor system of claim 12, wherein the brake comprises a yoke structure including an arch on each opposing lateral side of the yoke structure.

14. The belt conveyor system of claim 12, wherein the brake comprises a series of yoke structures.

15. The belt conveyor system of any of claims 1-7, wherein the brake is configured to lift the select ones of the one or more idler roller from a neutral position to a lifted position.

16. A belt conveyor system comprising:
one or more idler rollers;
a slave roller;
a drive roller coupled to the slave roller, wherein the drive roller configured to drive the slave roller;
a belt extending in a continuous loop wrapping around the one or more idler rollers, the slave roller, and the drive roller, wherein the slave roller is configured to drive the belt; and
a brake configured to actuate with at least one of: (i) the drive roller, (ii) the slave roller, and (iii) a portion of the belt in a position adjacent to the drive roller and the slave roller.

17. The belt conveyor system of claim 16, wherein the brake comprises a fixed U-shaped caliper configured externally of the continuous loop of the belt.

18. The belt conveyor system of claim 16 or claim 17, wherein the position adjacent to the drive roller and the slave roller is below at least one of the drive roller and the slave roller.

19. The belt conveyor system of any of claims 16-18, wherein the brake is actuated by applying the brake upwards from beneath the belt placing the brake in direct contact with the portion of the belt.

20. The belt conveyor system of any of claims 16-19, wherein the brake is configured to compress the portion of belt between the brake and at least one of the drive roller and the slave roller.

21. The belt conveyor system of claim 16, wherein the brake comprises a plate structure configured internally of the continuous loop of the belt, and on a side rail on at least one end of the drive roller and the slave roller.

22. The belt conveyor system of claim 16 or claim 21, wherein the brake is configured to apply frictional force to sidewalls portions of the drive roller and the slave roller.

23. The belt conveyor system of claim 16, wherein the brake comprises a butterfly structure configured within the continuous loop of the belt and between the drive roller and the slave roller.

24. The belt conveyor system of claim 16 or claim 23, wherein the brake is configured to actuate laterally in one or two directions towards the drive roller and the slave roller.

25. A belt conveyor system comprising:
one or more idler rollers comprising an internal brake;
a slave roller comprising an internal brake;
a drive roller coupled to the slave roller, wherein the drive roller configured to drive the slave roller;
a belt extending in a continuous loop wrapping around the one or more idler rollers, the slave roller, and the drive roller, wherein the slave roller is configured to drive the belt; and
wherein the internal brake of the one or more idler rollers and the internal brake of the slave roller are controlled and actuated by a controller associated with the drive roller.

26. A computer-implemented method for optimizing a lifespan of a belt conveyor, the computer-implemented method comprising:
receiving, by one or more processors, load and operating parameter data;
determining, by the one or more processors, a load runaway value based on the load and operating parameter data;
determining, by the one or more processors, whether a given load requires at least one of brake actuation and roller lifting based on the load runaway value;
generating, by the one or more processors, a signal causing at least one of brake activation and roller lifting based on the determination.

27. The computer-implemented method of claim 26 wherein the load and operating parameter data is associated with transport of the given load being on a belt conveyor.

28. The computer-implemented method of claim 26 or claim 27 wherein the load and operating parameter data comprises data representative of a weight of the given load, the given load's size, an angle of decline, and conveyor speed.

29. The computer-implemented method of any of claims 26-28 wherein the runaway value comprises an estimation of the given load's momentum based on load weight and conveyor speed.

30. The computer-implemented method of any of claims 26-29 wherein determining whether the given load requires at least one of brake actuation and roller lifting is further based on the load runway value exceeds a specific threshold.
